(19) United States
(12) Patent Application Publication
(10) Pub. No.: US 2017/0308927 A1
(43) Pub. Date: Oct. 26, 2017

(54) SYSTEMS AND METHODS FOR IDENTIFYING CONTENT SEGMENTS TO PROMOTE VIA AN ONLINE PLATFORM

(71) Applicant: DISNEY ENTERPRISES, INC., BURBANK, CA (US)

(72) Inventors: Michael Woods, Burbank, CA (US); Ryan Lissack, Burbank, CA (US)

(21) Appl. No.: 15/134,341

(22) Filed: Apr. 20, 2016

(51) Int. Cl. G06Q 30/02; H04L 29/08

(52) U.S. Cl. CPC G06Q 30/0254; G06Q 30/0277; H04L 67/32

(57) ABSTRACT

Content segments to promote on an online platform may be identified. Metadata associated with the content segments may be obtained. The metadata may include information describing the content segments. The content segments may be available to consumers via a first online platform. Confidence scores associated with the individual content segments may be determined based upon the metadata. The confidence scores may quantify a likelihood of success to direct consumers to the individual content segments on the first online platform from the second online platform. One of the content segments may be selected to promote on a second online platform based upon the confidence scores. The system may distribute promotional content associated with the selected content segment via the second online platform.

### FIELD

The disclosure relates to systems and methods for selecting a portion of a content segment to distribute via an online platform.

### BACKGROUND

Many online platforms exist for distributing, sharing, and/or promoting online content. A large amount of content may be available for consumers on a first online platform. Promotional content may be distributed to a second online platform to direct consumers to the content on the first online platform. Because of the large amount of content available on the first online platform, all of the content may not be promoted.

### SUMMARY

One aspect of the disclosure relates to a system configured for identifying content segments to promote via an online platform, in accordance with one or more implementations. A content segment may include one or more of an online video content, a social media content, an online photo content, audio content, and/or other online content. An online platform may include a networking platform a media platform, and/or other online platforms. The online platform may include the content segment and/or make the content segment available for consumption. For example, an online platform may include YouTube, Facebook, Twitter, Pinterest, LinkedIn, Google+, Flickr, Tumblr®, Blogger, Vine, Instagram, Snapchat, Maker.TV, and/or other online platforms. In exemplary implementations, the system may obtain metadata associated with the content segments. The metadata may include information describing the content segments, information relevant to content segments, information about consumption of content segments, information about electronic file(s) associated with content segments, and/or other information. Information describing the content segments may include one or more of channel information (e.g., a title, a tag, a description, a keyword, thumbnail information, a publish date, a number of views, and/or other channel information), file information (e.g., a file type, file size, a length of the individual content segments, resolution, encoding format, bit rate, and/or other file information), content information (e.g., music included in the content segments, images depicted in the content segments, objects included in the content segments, and/or text corresponding to dialogue of the content segments, and/or other content information), contextual information (e.g., trending topics, current popular topics being discussed on the online platforms, and/or other contextual information), and/or other information describing the content segments. The content segments may be available to consumers via a first online platform. The system may determine confidence scores associated with the individual content segments based upon the metadata. The confidence scores may quantify a likelihood of success to direct consumers to the individual content segments on the first online platform from one or more other online platforms (e.g., a second online platform and/or other online platforms). The confidence scores may be determined based upon the metadata related to the content segments including one or more of channel information, file information, content information, current topics, historical performance of related content segments, and/or any other information related to the content segments. The system may select one of the content segments to promote on one or more other online platforms (e.g., the second online platform, and/or other online platforms) based upon the confidence scores. The content segment may be selected based upon a comparison of the confidence scores associated with the individual content segments. The content segment with a confidence score that represents a higher likelihood of success compared to the other content segments may be selected (e.g., the content segment with the highest likelihood of success and/or another content segment that may have a higher likelihood of success in comparison to the other content segments). The promotional content associated with the selected content segment may be distributed via the second online platform. Promotional content may be content selected to entice and/or direct consumers to view the selected content segment on the first online platform. Promotional content may include less content than the individual content segment as a whole. For example, promotional content may include a snippet of an online video content, such as a preview of the online video content, an image from online video content, an image from a collection of images, and/or other portions of the selected content segment. The promotional content may be posted on a wall, channel, feed, board, or other section associated with the second online platform in order to entice and/or direct consumers to the selected content segment on the first online platform. The promotional content may include a recommendation for a consumer to distribute the promotional content, automatic distribution, and/or other distribution techniques and/or mechanisms.

In some implementations, the system may include one or more servers. The server(s) may be configured to communicate with one or more client computing platforms according to a client/server architecture. The consumers may access the system via client computing platform(s). The server(s) may be configured to execute computer readable instructions. The computer readable instructions may include one or more of a content component, a score determination component, a content selection component, a content distribution component, a consumer response component, and/or other components.

The content component may be configured to obtain metadata associated with the content segments. Metadata information may be stored by server(s) 102, client computing platforms 104, and/or other storage locations.

The score determination component may be configured to determine confidence scores associated with the individual content segments. The determination may be based upon the metadata. The determination may be based upon information describing the content segments including one or more of channel information associated with the content segments, file information associated with the content segments, content information associated with the content segments, contextual information associated with the content segments, and/or other information describing the content segments.

The content selection component may be configured to select one of the content segments to promote on the second online platform based upon the confidence scores. The content segment may be selected based upon comparing the confidence scores associated with the individual content segments. The content segment with a confidence score with a higher likelihood of success compared to the other content segments may be selected (e.g., the content segment with a confidence score with the highest likelihood of success and/or another content segment that may have a confidence score with a higher likelihood of success in comparison to the other confidence scores associated with other content segments).

The content distribution component may be configured to distribute promotional content associated with the selected content segment via the second online platform. Promotional content may be posted on a wall, channel, feed, board, or other section associated with the second online platform in order to entice and/or direct consumers to the selected content segment on the first online platform. The promotional content may include a recommendation for a consumer to distribute the promotional content, automatic distribution, and/or other distribution techniques and/or mechanisms.

The consumer response component may be configured to track consumer response to the promotional content by consumers that consume the promotional content on the second online platform. Consumer response may include any action the consumer may take during and/or after consuming the promotional content. Tracking consumer response to the promotional content on the second online platform may include one or more of tracking whether consumers up vote and/or promote the promotional content on the second online platform and/or which consumers up vote and/or promote the promotional content on the second online platform, tracking whether the consumers that consume the promotional content on the second online platform subsequently consume the selected content segment on the first online platform, tracking whether the consumers that consume the promotional content on the second online platform subsequently respond to a call to action within the selected content segment on the first online platform, tracking an amount of the selected content segment consumed by the individual consumers that consume the promotional content on the second online platform, and/or other tracking other actions taken by the consumer during and/or after consuming the promotional content.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured for identifying content segments to promote via an online platform, in accordance with one or more implementations.

FIG. 2 illustrates an exemplary graph depicting consumer engagement of a content segment over time, in accordance with one or more implementations.

FIG. 3 illustrates an exemplary view of an implementation of the system of FIG. 1.

FIG. 4 illustrates a method for identifying content segments to promote via an online platform, in accordance with one or more implementations.

### DETAILED DESCRIPTION

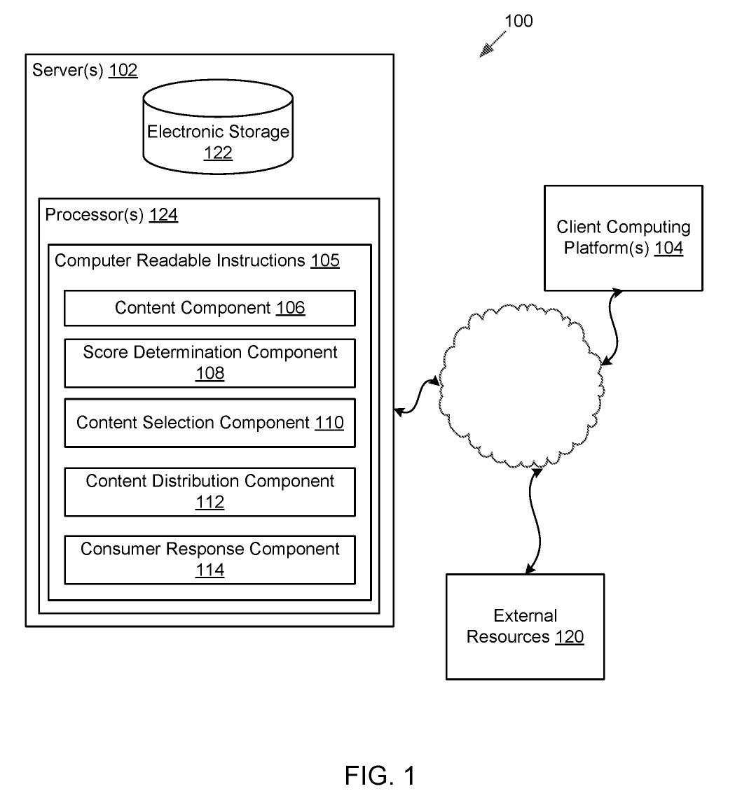

FIG. 1 illustrates a system 100 configured for identifying content segments to promote via an online platform, in accordance with one or more implementations. A content segment may include one or more of an online video content, a social media content, an online photo content, audio content, and/or other online content. An online platform may include a networking platform a media platform, and/or other online platforms. The online platform may include the content segment and/or make the content segment available for consumption. For example, an online platform may include YouTube, Facebook, Twitter, Pinterest, LinkedIn, Google+, Flickr, Tumblr, Blogger, Vine, Instagram, Snapchat, Maker.TV and/or other online platforms.

In exemplary implementations, system 100 may obtain metadata associated with the content segments. The metadata may include information describing the content segments, information relevant to content segments, information about consumption of content segments, information about electronic file(s) associated with content segments, and/or other information. Information describing the content segments may include one or more of channel information (e.g. a title, a tag, a description, a keyword, thumbnail information, a publish date, a number of views, and/or other channel information), file information (e.g., a file type, file size, a length of the individual content segments, resolution, encoding format, bit rate, and/or other file information), content information (e.g., music included in the content segments, images depicted in the content segments, objects included in the content segments, and/or text corresponding to dialogue of the content segments, and/or other content information), contextual information (e.g., trending topics, current popular topics being discussed on the online platforms, and/or other contextual information), and/or other information describing the content segments. The content segments may be available to consumers via a first online platform.

System 100 may determine confidence scores associated with the individual content segments based upon the metadata. The confidence scores may quantify a likelihood of success to direct consumers to the individual content segments on the first online platform from one or more other online platforms (e.g., a second online platform and/or other online platforms). The confidence scores may be determined based upon the metadata related to the content segments including one or more of channel information, file information, content information, current topics, historical performance of related content segments, and/or any other information related to the content segments. Confidence scores may be a sliding scale of numerical values (e.g., 1, 2, . . . n, where a number may be assigned as low and/or high), verbal levels (e.g., very low, low, medium, high, very high, and/or other verbal levels), and/or any other scheme to represent a confidence score. Individual content segments may have one or more confidence scores associated with it. An aggregate confidence score for a content segment may represent a likelihood of success over multiple online platforms. The aggregate confidence score may be determined based on a combination of confidence scores associated with the individual online platforms, metadata associated with the content segment, and/or other basis.

System 100 may select one of the content segments to promote on one or more other online platforms (e.g., the second online platform, and/or other online platforms) based upon the confidence scores. The content segment may be selected based upon a comparison of the confidence scores associated with the individual content segments. The content segment with a confidence score that represents a higher likelihood of success compared to the other content segments may be selected (e.g., the content segment with the highest likelihood of success and/or another content segment that may have a higher likelihood of success in comparison to the other content segments).

System 100 may distribute promotional content associated with the selected content segment via the second online platform. Promotional content may be content selected to entice and/or direct consumers to view the selected content segment on the first online platform. Promotional content may include less content than the individual content segment as a whole. For example, promotional content may include a snippet of an online video content, such as a preview of the online video content, an image from online video content, an image from a collection of images, and/or other portions of the selected content segment. The promotional content may be posted on a wall, channel, feed, board, or other section associated with the second online platform in order to entice and/or direct consumers to the selected content segment on the first online platform. The promotional content may include a recommendation for a consumer to distribute the promotional content, automatic distribution, and/or other distribution techniques and/or mechanisms.

In some implementations, system 100 may include one or more servers 102. Server(s) 102 may be configured to communicate with one or more client computing platforms 104 according to a client/server architecture. The consumers may access system 100 via client computing platform(s) 104. Server(s) 102 may be configured to execute computer readable instructions 105. Computer readable instructions 105 may include one or more of content component 106, score determination 108, content selection component 110, content distribution component 112, consumer response component 114, and/or other components.

Content component 106 may be configured to obtain metadata associated with the content segments. Metadata information may be stored by server(s) 102, client computing platforms 104, and/or other storage locations.

Score determination component 108 may be configured to determine confidence scores associated with the individual content segments. The determination may be based upon the metadata. The determination may be based upon information describing the content segments including one or more of channel information associated with the content segments, file information associated with the content segments, content information associated with the content segments, contextual information associated with the content segments, and/or other information describing the content segments.

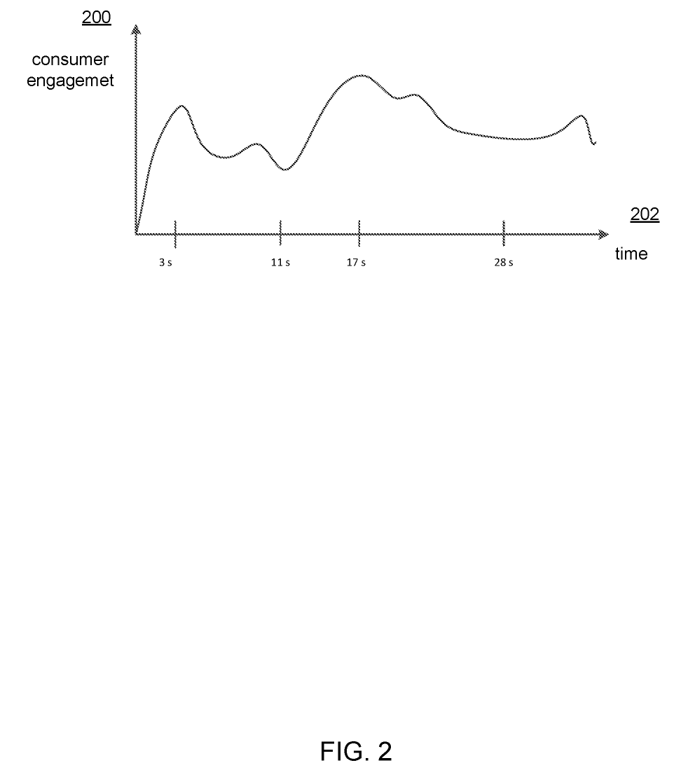

Determining the confidence scores may be based upon channel information associated with the content segments. Channel information associated with the content segments may include, for example, one or more of a title for the individual content segments, a thumbnail, caption information, individual content segment description information, search engine optimization keywords, a publish date, a number of views, a playlist, viewer engagement and/or retention information associated with the individual content segments (e.g., see FIG. 2, information indicating frequently watched portions the individual content segments and/or points where consumers typically stop watching the individual content segments), rating information (e.g., consumer ratings and/or content rating indicating suitability of the online content to its audience), and/or other channel information associated with the content segments. For example, content segments with high ratings and/or positive feedback/comments may be associated with a confidence score representing a higher likelihood of success than content segments with low ratings and/or negative feedback/comments. Content segments that may be more than one year old may be associated with a confidence score representing a lower likelihood of success than more recent content segments. These examples are not meant to be a limitation of this disclosure, as content segments may be associated with confidence scores representing a higher and/or lower likelihood of success based upon various other factors. Confidence scores may change based upon other factors.

The confidence scores may quantify a likelihood of success to direct consumers to the individual content segments on the first online platform from a second online platform. A likelihood of success to direct consumers to the individual content segments on the first online platform from the second online platform may represent a varying success rates associated with one or more consumer actions including engaging in click throughs, viewing the individual content segments, engaging in calls to action, viewing other related content segments, and/or other consumer actions. The likelihood of the consumer actions may be represented via one confidence score per online platform, multiple confidence scores for a single online platform, and/or multiple confidence scores per online platform.

Referring to FIG. 2, an exemplary graph depicting consumer engagement 200 of an individual content segment on the first online platform over span of time 202 is provided. As shown in FIG. 2, a graph of consumer engagement 200 for a content segment is plotted over span of time 202 for the content segment. Consumer engagement 200 for the content segment may reach a first peak at 3 seconds, while consumer engagement 200 may reach the lowest valley at 11 seconds. This may be due to consumers losing interest in the content or subject matter for the content segment. Consumer engagement may then reach the highest peak at 17 seconds, and consumer engagement may plateau around 28 seconds of the content segment. For example, a content segment with relatively high and/or consistent consumer engagement may be associated with a confidence score representing a higher likelihood of success. Alternatively, a content segment with relatively low and/or inconsistent consumer engagement may be associated with a confidence score representing a lower likelihood of success. These examples are not meant to be a limitation of this disclosure, as content segments may be associated with confidence scores representing a higher and/or lower likelihood of success based upon various other factors. While seconds have been used as a unit of time in FIG. 2, this is for exemplary purposes only and is not meant to be a limitation of this disclosure. Time 202 may include any unit of time including minutes, hours, and/or other units of time.

Determining the confidence scores may be based upon file information associated with the content segments. File information associated with the content segments may include, for example, one or more of a file type (e.g., e.g., .JPG, .PNG, .MOV, .MPEG4, .MP4, .AVI, .WMV, .MPEGPS, .FLV., 3GPP, and/or other file types), file size, a length of the individual content segments, resolution, encoding format, bit rate, and/or other file information associated with the content segments. For example, content segments less than five minutes in length may be associated with a confidence score representing a higher likelihood of success. This example is not meant to be a limitation of this disclosure, as content segments may be associated with confidence scores representing a higher and/or lower likelihood of success based upon various other factors.

Determining the confidence scores may be based upon content information associated with the content segments. Content information associated with the content segments may describe content of the content segments. Content information may include, for example, one or more of music included in the content segments, images depicted in the content segments, objects included in the content segments, text corresponding to dialogue of the content segments, and/or other content or types of content included within the content segments. The content information may include temporal information associated with the content included within the content segments. The temporal information may indicate points in time within the content segments associated with individual ones of the content included in the content segments. As such, for example, the temporal information associated with an image depicted in the content segments may indicate a point in time within the duration of the content segments where the image is presented. Content information may be used to identify one or more events within the content segments.

The content information and/or temporal information may indicate the content that appears and/or is presented within the content segments and when. For example, the content information may include the name of a song that is presented within an individual content segment and the time interval at which it is presented.

Determining the confidence scores may be based upon a comparison between the metadata and current topics. Current topics may include information “trending” on online platforms. Current and/or “trending” topics may be obtained from consumer posts, tags (e.g., hashtags and/or other tags), comments on posts, and/or other consumer actions on various platforms. If metadata associated with the individual content segments relate to one or more current topics associated with any of the online platforms (e.g., one or more current topics frequently discussed and/or posted on any of the platforms), the individual content segment may be associated with a confidence score representing a higher likelihood of success. A confidence score representing a higher likelihood of success may be associated with the individual content segment if more consumers are posting and/or commenting about a current topic relevant to the individual content segment. These examples are not meant to be a limitation of this disclosure, as content segments may be associated with confidence scores representing a higher and/or lower likelihood of success based upon various other factors.

Confidence scores may be specific to a particular second online platform. One or more confidence scores may be determined for an individual content segment. One confidence score may be specific to one platform (e.g., Facebook), while another confidence score may be specific to another platform (e.g., Twitter). The confidence scores for individual content segments may vary based upon consumer demographics associated with the second online platform. Consumer demographics associated with the second online platform may include information relating to one or more of information and/or statistics related to a consumer population of the second online platform, as reflected by consumer profiles associated with the second online platform. Examples of consumer demographics may include age, gender, race, ethnicity, occupation, income level, education level, employment status, geographic location, marital status, language, and/or other demographic information. Individual content segments may appeal to a particular consumers based upon consumer demographics. For example, the content segment including an animated character may appeal more to a younger consumer demographic than an adult consumer demographic. As such, content segments including an animated character may be associated with a confidence score representing a higher likelihood of success for an online platform with a young consumer demographic and a confidence score representing a lower likelihood of success for a different online platform with an adult consumer demographic. These examples are not meant to be a limitation of this disclosure, as content segments may be associated with confidence scores representing a higher and/or lower likelihood of success based upon various other factors.

Determining the confidence scores may be based upon historical performance of related content segments. Determining the confidence scores based upon historical performance of related content segments may be based upon how similar the related content segments are to the individual content segments and how successful the related content segments were in directing consumers to the related content segments on the first online platform from a second online platform. Related content segments may include, for example, one or more of the same or similar talent included within the content segments (e.g., actor, actress, athlete, performer, and/or other talent), topics within the content segments (e.g., genre, subject matter, sports, and/or other topics), audience (the individual content segments appeal to the same or similar audience as the related content segments), and/or other related content within the content segments. For example, if a related content segment included the same actor as one of the content segments and was not as successful in directing consumers to the first online platform from the second online platform as another related content segment, then that individual content segment may be associated with a confidence score representing a lower likelihood of success. If the related content segment included the same comedian as one of the content segments and was more successful in directing consumers to the first online platform from the second online platform than another related content segment, then that individual content segment may be associated with a confidence score representing a higher likelihood of success. These examples are not meant to be a limitation of this disclosure, as content segments may be associated with confidence scores representing a higher and/or lower likelihood of success based upon various other factors.

As noted above, individual content segments may be associated with one or more confidence scores. An individual content segment may be associated with multiple confidence scores for different online platforms. Confidence scores associated with individual content segments may vary based upon any number of factors. Confidence scores associated with an individual content segment may remain separate and/or may be aggregated, averaged, added together, and/or combined and/or manipulated in any other way.

Referring back to FIG. 1, content selection component 110 may be configured to select one of the content segments to promote on the second online platform based upon the confidence scores. The content segment may be selected based upon comparing the confidence scores associated with the individual content segments. The content segment with a confidence score representing a higher likelihood of success compared to the other content segments may be selected (e.g., the content segment with a confidence score representing the highest likelihood of success and/or another content segment that may have a confidence score representing a higher likelihood of success in comparison to the other content segments).

Content distribution component 112 may be configured to distribute promotional content associated with the selected content segment via the second online platform. Promotional content may be posted on a wall, channel, feed, board, or other section associated with the second online platform in order to entice and/or direct consumers to the selected content segment on the first online platform. The promotional content may include a recommendation for a consumer to distribute the promotional content, automatic distribution, and/or other distribution techniques and/or mechanisms.

Consumer response component 112 may be configured to track consumer response to the promotional content by consumers that consume the promotional content on the second online platform. Consumer response may include any action the consumer may take during and/or after consuming the promotional content. Tracking consumer response to the promotional content on the second online platform may include one or more of tracking whether consumers up vote and/or promote the promotional content on the second online platform and/or which consumers up vote and/or promote the promotional content on the second online platform, tracking whether the consumers that consume the promotional content on the second online platform subsequently consume the selected content segment on the first online platform, tracking whether the consumers that consume the promotional content on the second online platform subsequently respond to a call to action within the selected content segment on the first online platform, tracking an amount of the selected content segment consumed by the individual consumers that consume the promotional content on the second online platform, and/or other tracking other actions taken by the consumer during and/or after consuming the promotional content.

Tracking consumer response to the promotional content on the second online platform may include tracking whether consumers up vote and/or promote the promotional content on the second online platform and/or which consumers up vote and/or promote the promotional content on the second online platform. Tracking which consumers up vote and/or promote the promotional content on the second online platform may include obtaining some or all of the user information for consumers held in online profiles associated with the consumers on the second online platform. The user information may include one or more of the name, username, interests, demographic information, and/or other online profile information. Up voting the promotional content may include “liking”, rating, thumbs-upping, commenting, and/or otherwise up voting the promotional content on the second online platform. Promoting the promotional content may include sharing, posting, linking, emailing, and/or otherwise promoting the promotional content on the second online platform. Promoting the promotional content may include promoting the promotional content on another platform separate from the second online platform for other consumers to view.

Tracking consumer response to the promotional content by consumers that consume the promotional content on the second online platform may include tracking whether the consumers that consume the promotional content on the second online platform subsequently consume the selected content segment on the first online platform. Tracking whether the consumers that consume the promotional content on the second online platform subsequently consume the selected content segment on the first online platform may include tracking whether consumers follow (e.g., click) a link associated with the promotional content on the second online platform. Following the link associated with the promotional content on the second online platform may redirect the consumer to the selected content segment on the first online platform. Redirecting the consumer to the first online platform may include redirecting the consumer within the same application as the second online platform, redirecting the consumer via a separate pop-up window, and/or redirecting the consumer in a separate application such that the consumer may view the selected content segment on the first online platform. Tracking consumer response to the promotional content by consumers that consume the promotional content on the second online platform may include tracking which consumers that consume the promotional content on the second online platform subsequently consume the selected content segment on the first online platform based upon profile information associated with the consumer on the second online platform.

Tracking response to the promotional content by consumers that consume the promotional content on the second online platform may include tracking whether the consumers that consume the promotional content on the second online platform subsequently respond to a call to action within the selected content segment on the first online platform. A call to action within the selected content segment on the first online platform may include prompting the consumer what to do next directly within the selected content segment and/or via annotations (e.g., popup annotations, text reminding consumers to subscribe to a channel, comments on and/or within the selected content segment, instructions to view a related content segment, and/or other annotations), advertisement overlays during consumption of the selected content segment, and/or other call to actions within the selected content segment on the first online platform. Tracking response to the promotional content by consumers that consume the promotional content on the second online platform may include tracking which consumers that consume the promotional content on the second online platform subsequently respond to a call to action within the selected content segment on the first online platform based upon profile information associated with the consumer on the second online platform and/or profile information associated with the consumer on the first online platform.

Tracking response to the promotional content by consumers that consume the promotional content on the second online platform may include tracking an amount of the selected content segment consumed by the individual consumers that consume the promotional content on the second online platform. Tracking the amount of the selected content segment consumed by the individual consumers that consume the promotional content on the second online platform may include tracking an amount of time the individual consumers view the selected content segment on the first online platform, how many times the individual consumers view the selected content segment on the first online platform, whether the individual consumers skip to particular parts of the selected content segment, and/or otherwise tracking the amount of the selected content segment individual consumers view.

In some implementations, score determination component 108 may be configured to determine a confidence score for a second content segment to promote on the second online platform. The confidence score for the second content segment may be based upon the tracking of consumer response to the promotional content by consumers that consume the promotional content on the second online platform. System 100 may learn from tracking consumer response to the promotional content in order to predict determining a confidence score for a second content segment to promote on the second online platform. For example, if the promotional content for the selected content segment including a Disney star that was distributed to a particular second online platform attracted a high volume of consumers to the first online platform, many of whom viewed the entire length of the selected content segment, a similar confidence score may be associated with a second content segment featuring the same or different Disney star. The confidence score for the second content may or may not be specific to the second online platform. More than one confidence score may be determined for the second content segment. This example is not meant to be limiting, as the confidence score may vary for a second content segment based upon various factors, one of which may include the tracking of consumer response to the promotional content by consumers that consume the promotional content on the second online platform.

The confidence score associated with the selected content segment may be adjusted based upon the tracking of consumer response to the promotional content by consumers that consume the promotional content on the second online platform. For example, if a low number of consumers that consume the promotional content on the second online platform subsequently consume the content segment on the first online platform, the confidence score for the selected content segment may be lowered. This example is not meant to be a limitation of this disclosure, as confidence scores associated with the selected content segment may be adjusted based upon various other factors

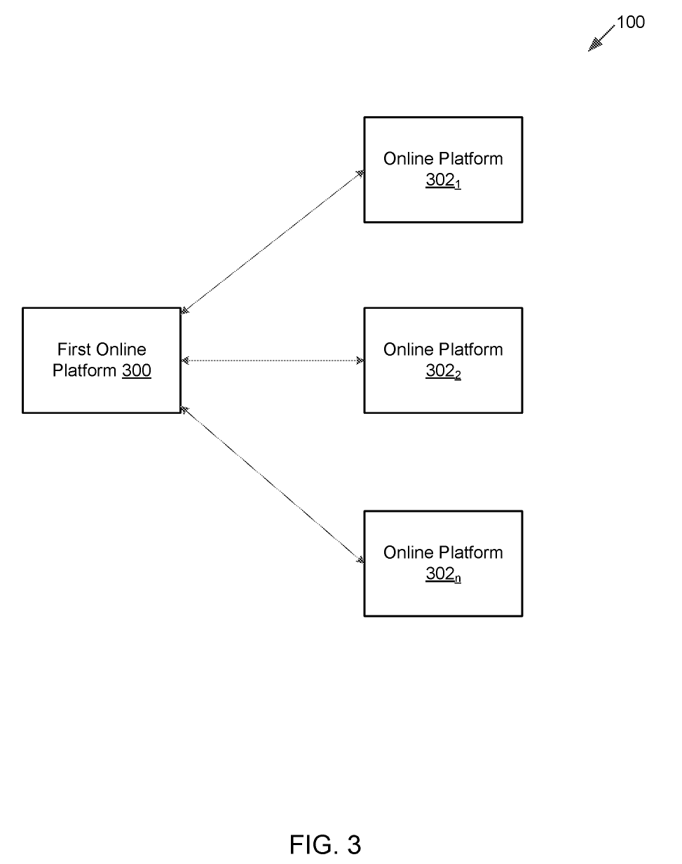

Referring to FIG. 3, an exemplary view of an implementation of the system of FIG. 1 is depicted. Content segments may be available for consumers to view on first online platform 300. Confidence scores may be associated with individual content segments on first online platform 300 based upon metadata associated with the individual content segments. One of the content segments may be selected to be promoted on one or more online platforms 302₁, 302₂, . . . , 302, (collectively second online platform 302). The selection may be based upon the confidence scores. The confidence scores may be determined based upon channel information, file information, content information, current topics, historical performance of related content segments, a particular second online platform 302, and/or other information and/or factors. Confidence scores associated with individual content segments may vary. Promotional content associated with a selected content segment may be distributed to second online platform 302 in order to entice and/or direct consumers back to the selected content segment on first online platform 300. Once distributed, consumer response to the promotional content that has been published and/or posted to second online platform 302 may be tracked. Tracking consumer response to the promotional content that has been distributed to second online platform 302 may include one or more of tracking whether the consumers subsequently consume the selected content segment on first online platform 300, tracking whether the consumers subsequently respond to a call to action within the selected content segment on first online platform 300, tracking an amount of the selected content segment on first online platform 300 that has been consumed by the individual consumers, and/or tracking whether individual consumers subsequently consume the selected content segment on first online platform 300 and then proceed to view related content segments on first online platform 300. Based on this information, system 100 may then determine a confidence score for a second content segment to promote on second online platform 302 to direct consumers to the second content segment on first online platform 300.

Referring again to FIG. 1, in some implementations, server(s) 102, client computing platform(s) 104, and/or external resources 120 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 102, client computing platform(s) 104, and/or external resources 120 may be operatively linked via some other communication media.

A given client computing platform 104 may include one or more processors configured to execute computer program components. The computer program components may be configured to enable a producer and/or user associated with the given client computing platform 104 to interface with system 100 and/or external resources 120, and/or provide other functionality attributed herein to client computing platform(s) 104. By way of non-limiting example, the given client computing platform 104 may include one or more of a desktop computer, a laptop computer, a handheld computer, a NetBook, a Smartphone, a gaming console, and/or other computing platforms.

External resources 120 may include sources of information, hosts and/or providers of virtual environments outside of system 100, external entities participating with system 100, and/or other resources. In some implementations, some or all of the functionality attributed herein to external resources 120 may be provided by resources included in system 100.

Server(s) 102 may include electronic storage 122, one or more processors 124, and/or other components. Server(s) 102 may include communication lines, or ports to enable the exchange of information with a network and/or other computing platforms. Illustration of server(s) 102 in FIG. 1 is not intended to be limiting. Servers(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 122 may include electronic storage media that electronically stores information. The electronic storage media of electronic storage 122 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 122 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 122 may include one or more virtual storage resources (e.g., cloud storage, a virtual private network, and/or other virtual storage resources). Electronic storage 122 may store software algorithms, information determined by processor(s) 124, information received from server(s) 102, information received from client computing platform(s) 104, and/or other information that enables server(s) 102 to function as described herein.

Processor(s) 124 may be configured to provide information processing capabilities in server(s) 102. As such, processor(s) 124 may include one or more of a digital processor, an analog processor, a digital circuit designed to process information, an analog circuit designed to process information, a state machine, and/or other mechanisms for electronically processing information. Although processor(s) 124 is shown in FIG. 1 as a single entity, this is for illustrative purposes only. In some implementations, processor(s) 124 may include a plurality of processing units. These processing units may be physically located within the same device, or processor(s) 124 may represent processing functionality of a plurality of devices operating in coordination. The processor(s) 124 may be configured to execute computer readable instruction components 106, 108, 110, 112, 114, and/or other components. The processor(s) 124 may be configured to execute components 106, 108, 110, 112, 114, and/or other components by software; hardware; firmware; some combination of software, hardware, and/or firmware; and/or other mechanisms for configuring processing capabilities on processor(s) 124.

It should be appreciated that although components 106, 108, 110, 112, and 114 are illustrated in FIG. 1 as being co-located within a single processing unit, in implementations in which processor(s) 124 includes multiple processing units, one or more of components 106, 108, 110, 112, and 114 may be located remotely from the other components. The description of the functionality provided by the different components 106, 108, 110, 112, and/or 114 described herein is for illustrative purposes, and is not intended to be limiting, as any of components 106, 108, 110, 112, and/or 114 may provide more or less functionality than is described. For example, one or more of components 106, 108, 110, 112, and/or 114 may be eliminated, and some or all of its functionality may be provided by other ones of components 106, 108, 110, 112, and/or 114. As another example, processor(s) 124 may be configured to execute one or more additional components that may perform some or all of the functionality attributed herein to one of components 106, 108, 110, 112, and/or 114.

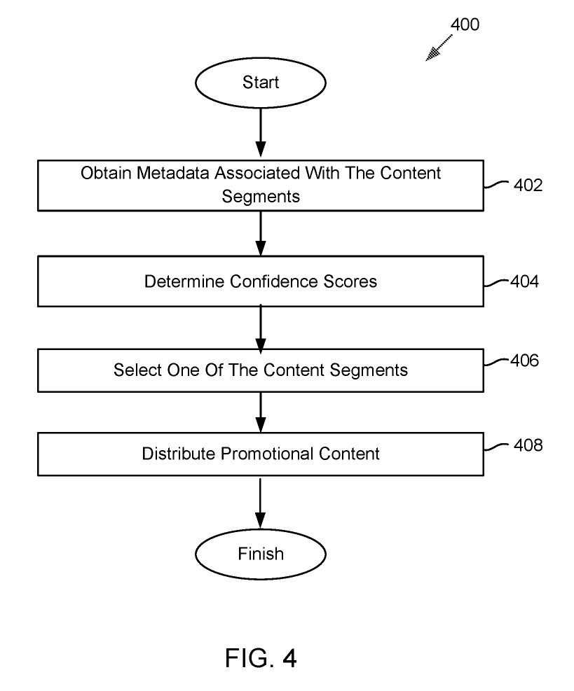

FIG. 4 illustrates a method 400 for selecting a portion of a content segment to distribute via an online platform, in accordance with one or more implementations. The operations of method 400 presented below are intended to be illustrative. In some implementations, method 400 may be accomplished with one or more additional operations not described, and/or without one or more of the operations discussed. Additionally, the order in which the operations of method 400 are illustrated in FIG. 4 and described below is not intended to be limiting.

In some implementations, method 400 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 400 in response to instructions stored electronically on an electronic storage medium. The one or more processing devices may include one or more devices configured through hardware, firmware, and/or software to be specifically designed for execution of one or more of the operations of method 400.

At an operation 402, metadata associated with content segments may be obtained. The metadata may include information describing the content segments. The content segments may be available to consumers via a first online platform. Operation 402 may be performed by a content component that is the same as or similar to content component 106, in accordance with one or more implementations.

At an operation 404, confidence scores associated with individual content segments may be determined. The confidence scores may quantify a likelihood of success to direct consumers to the individual content segments on the first online platform from a second online platform. The determination may be based upon the metadata. Operation 404 may be performed by a score determination component that is the same as or similar to score determination component 108, in accordance with one or more implementations.

At an operation 406, one of the content segments may be selected to be promoted on the second online platform. The selection may be based upon the confidence scores. Operation 406 may be performed by a content selection component that is the same as or similar to content selection component 110, in accordance with one or more implementations.

At an operation 408, promotional content associated with the selected content segment may be distributed via the second online platform. Operation 408 may be performed by a content distribution component that is the same as or similar to content distribution component 112, in accordance with one or more implementations.

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

What is claimed is:

1. A system for identifying content segments to promote via an online platform, the system comprising:
one or more physical processors configured by machine-readable instructions to:
obtain metadata associated with the content segments, the metadata including information describing the content segments, wherein the content segments are available to consumers via a first online platform;
determine confidence scores associated with individual content segments based upon the metadata, the confidence scores quantifying a likelihood of success to direct consumers to the individual content segments on the first online platform from a second online platform;
select one of the content segments to promote on the second online platform based upon the confidence scores; and
distribute promotional content associated with the selected content segment via the second online platform.

2. The system of claim 1, wherein the one or more physical processors are further configured by computer-readable instructions such that determining the confidence scores is based upon channel information associated with the content segments, wherein channel information includes one or more of a title, a tag, a description, a keyword, thumbnail information, a publish date, and/or a number of views.

3. The system of claim 1, wherein the one or more physical processors are further configured by computer-readable instructions such that determining the confidence scores is based upon file information associated with the content segments, wherein file information includes one or more of a file type, file size, a length of the individual content segments, resolution, encoding format, and/or bit rate.

4. The system of claim 1, wherein the one or more physical processors are further configured by computer-readable instructions such that determining the confidence scores is based upon content information associated with the content segments, wherein content information includes one or more of music included in the content segments, images depicted in the content segments, objects included in the content segments, and/or text corresponding to dialogue of the content segments, and wherein the content information includes temporal information indicating points in time within the content segments associated with individual ones of the content included in the content segments.

5. The system of claim 1, wherein the one or more physical processors are further configured by computer-readable instructions such that determining the confidence scores is based upon a comparison between the metadata and current topics.

6. The system of claim 1, wherein the one or more physical processors are further configured by computer-readable instructions such that the confidence scores are specific to the second platform.

7. The system of claim 1, wherein the one or more physical processors are further configured by computer-readable instructions such that determining the confidence scores is based upon historical performance of related content segments.

8. The system of claim 1, wherein the one or more physical processors are further configured by computer-readable instructions to:
track consumer response to the promotional content by consumers that consume the promotional content on the second platform.

9. The system of claim 8, wherein tracking response to the promotional content by consumers that consume the promotional content on the second platform includes tracking whether the consumers that consume the promotional content on the second platform subsequently consume the selected content segment on the first platform.

10. The system of claim 8, wherein the one or more physical processors are further configured by computer-readable instructions to:
determine a confidence score for a second content segment to promote on the second platform based upon the tracking of consumer response to the promotional content by consumers that consume the promotional content on the second platform.

11. A method for identifying content segments to promote via an online platform, the method being implemented by a computer system including one or more physical processors configured by machine-readable instructions, the method comprising:
obtaining metadata associated with the content segments, the metadata including information describing the content segments, wherein the content segments are available to consumers via a first online platform;
determining confidence scores associated with individual content segments based upon the metadata, the confidence scores quantifying a likelihood of success to direct consumers to the individual content segments on the first online platform from a second online platform;
selecting one of the content segments to promote on the second online platform based upon the confidence scores; and
distributing promotional content associated with the selected content segment via the second online platform.

12. The method of claim 11, wherein determining the confidence scores is based upon channel information associated with the content segments, and wherein channel information includes one or more of a title, a tag, a description, a keyword, thumbnail information, a publish date, and/or a number of views.

13. The method of claim 11, wherein determining the confidence scores is based upon file information associated with the content segments, and wherein file information includes one or more of a file type, file size, a length of the individual content segments, resolution, encoding format, and/or bit rate.

14. The method of claim 11, wherein determining the confidence scores is based upon content information associated with the content segments, wherein content information includes one or more of music included in the content segments, images depicted in the content segments, objects included in the content segments, and/or text corresponding to dialogue of the content segments, and wherein the content information includes temporal information indicating points in time within the content segments associated with individual ones of the content included in the content segments.

15. The method of claim 11, wherein determining the confidence scores is based upon a comparison between the metadata and current topics.

16. The method of claim 11, wherein the confidence scores are specific to the second platform.

17. The method of claim 11, wherein determining the confidence scores is based upon historical performance of related content segments.

18. The method of claim 11, further comprising:
tracking consumer response to the promotional content by consumers that consume the promotional content on the second platform.

19. The method of claim 18, wherein tracking response to the promotional content by consumers that consume the promotional content on the second platform includes tracking whether the consumers that consume the promotional content on the second platform subsequently consume the selected content segment on the first platform.

20. The method of claim 18, further comprising:
determining a confidence score for a second content segment to promote on the second platform based upon the tracking of consumer response to the promotional content by consumers that consume the promotional content on the second platform.
